(19) United States
(12) Patent Application Publication
(10) Pub. No.: US 2026/0109829 A1
(43) Pub. Date: Apr. 23, 2026

(54) MELT PROCESSABLE AND FOAMABLE CELLULOSE ACETATE FORMULATIONS CONTAINING NATURAL FILLERS

(71) Applicant: Eastman Chemical Company, Kingsport, TN (US)

(72) Inventors: Yichen Fang, Wilmington, DE (US); Goliath Beniah, York, PA (US); Michael Eugene Donelson, Kingsport, TN (US)

(73) Assignee: Eastman Chemical Company, Kingsport, TN (US)

(21) Appl. No.: 19/113,248

(22) PCT Filed: Sep. 21, 2023
(86) PCT No.: PCT/US2023/074750

§ 371 Date: Mar. 19, 2025

Related U.S. Application Data
(60) Provisional application No. 63/409,385, filed on Sep. 23, 2022.

(51) Int. Cl. C08J 9/08; C08B 3/06; C08K 11/00

(52) U.S. Cl. CPC C08J 9/08; C08B 3/06; C08K 11/005; C08J 2203/02

(57) ABSTRACT

The present application discloses a foamable composition comprising 30 to 92 wt % cellulose acetate: 5 to 30 wt % of at least one plasticizer: 3 to 40 wt % of at least one natural filler; and 0) to 9 wt % of at least one physical blowing agent. The composition can be used to prepare biodegradable foam and foam articles having densities, cell sizes, mechanical and thermal properties appropriate for low and medium density foam applications.

### BACKGROUND OF THE INVENTION

Foamed materials are useful in applications such as insulating, food packaging, nonfood packaging, and sound proofing. Many food service articles are single-use items that are intended to be disposed of after the food packaging has been opened or the food has been served. One commercially important material used to make foam food packaging articles is polystyrene. However, polystyrene is neither compostable nor biodegradable. Moreover, some municipalities, states, and countries have enacted or are considering enacting bans on the use polystyrene based foams. In addition to the non-biodegradability of the polystyrene, many of the polystyrene foams utilize talc as an inorganic physical nucleating agent to initiate the formation of the foam cells. There may be health and safety concerns regarding the use of talc in products intended for food contact applications.

Cellulose acetate based foams can be biodegradable and can be used as a replacement for polystyrene foams. However, there is a need for cellulose acetate based foams must demonstrate appropriate densities (≤0.400 g/cm³ for low density applications, or greater than 0.400 g/cm³ up to 1.0 g/cm³ for medium density applications) as well as good thermal and mechanical properties. Cellulose acetate based foams must be processable on commercial extrusion equipment and, desirably, have the ability to be thermoformed on commercial thermoforming equipment. Natural fillers can also be biodegradable and can serve as a physical nucleating agent during the foaming process. Furthermore, because of their hygroscopic nature, natural fillers can serve as a carrier of water which acts as a physical blowing agent during the foaming process, helping to reduce the density of the resulting foam. Because natural fillers are less expensive than cellulose acetate resins, they can simultaneously reduce the raw material cost of cellulose acetate based foamable compositions while also imparting improved foam properties by serving as a physical nucleating agent and/or a physical blowing agent.

### SUMMARY OF THE INVENTION

The present application discloses a foamable composition comprising 30 to 92 wt % cellulose acetate, 5 to 30 wt % of at least one plasticizer, 3 to 40 wt % of at least one natural filler, and 0 to 9 wt % of at least one physical blowing agent; wherein wt % is based on the total weight of all components of the composition. The foamable composition can be formed into biodegradable cellulose acetate foam having a density of from 0.040 to 0.600 g/cm³, an average foam cell size of from 20 to 600 microns, and an appearance which is readily distinguishable from polystyrene foam. The biodegradable cellulose acetate foam can be formed into articles.

### DETAILED DESCRIPTION OF THE INVENTION

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

Nucleating agent means a chemical or physical material that provides sites for cells to form in a molten formulation mixture. Nucleating agents may include chemical nucleating agents and physical nucleating agents. The nucleating agent may be blended with the formulation that is introduced into the hopper of the extruder. Alternatively, the nucleating agent may be added to the molten resin mixture in the extruder.

Suitable physical nucleating agents have desirable particle size. Examples of inorganic physical nucleating agents include, but are not limited to, talc, CaCO₃, mica, and mixtures of at least two of the foregoing. One representative example is Heritage Plastics HT6000 Linear Low Density Polyethylene (LLDPE) Based Talc Concentrate. It has been discovered that biodegradable particulate natural fillers derived from renewable organic sources can also serve as effective physical nucleating agents. Examples of Natural Fillers that can be physical nucleating agents include, but are not limited to, Pecan Shell Flour, Walnut Shell Flour, Wood Flour, Corn Cob Flour, Rice Hull Flour, and Oat Fiber Powder. One representative example of an organic physical nucleating agent is Oat Fiber Powder commercially available from NuNatural.

Suitable chemical nucleating agents decompose to create cells in the molten formulation when a chemical reaction temperature is reached. These small cells act as nucleation sites for larger cell growth from a physical or other type of blowing agent. Examples of chemical nucleating agents include but are not limited to citric acid or a citric acid-based material. One representative example is HYDROCEROL™ CF-40E (available from Clariant Corporation), which contains citric acid and a crystal nucleating agent.

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agent acts to reduce density by expanding cells formed in the molten formulation at the nucleation sites. The blowing agent may be added to the molten resin mixture in the extruder. It has been surprisingly discovered that the hygroscopic nature of biodegradable particulate natural fillers allows them to absorb moisture and carry the absorbed water into the molten resin mixture where it can act as a physical blowing agent.

Chemical blowing agents are materials that degrade or react to produce a gas. Chemical blowing agents may be endothermic or exothermic. Chemical blowing agents typically degrade at a certain temperature to decompose and release gas. Examples of chemical blowing agents include citric acid, sodium bicarbonate, sodium carbonate, ammonium bicarbonate, ammonium carbonate, and the like.

Examples of physical blowing agents include H₂O, N₂, CO₂, alkanes, alkenes, ethers, ketones, argon, helium, air or mixtures. As noted above, hygroscopic biodegradable natural fillers can be formulated into a composition and allowed to absorb moisture prior to the foaming process, where the water then is released to act as a physical blowing agent.

In embodiments, the cellulose acetate utilized in this invention can be any that is known in the art and that is biodegradable. Cellulose acetate that can be used for the present invention generally comprise repeating units of the structure:

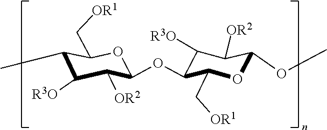

wherein R¹, R², and R³ are selected independently from the group consisting of hydrogen or acetyl. For cellulose esters, the substitution level is usually express in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In embodiments, n is an integer in a range from 25 to 250, or 25 to 200, or 25 to 150, or 25 to 100, or 25 to 75.

In embodiments of the invention, the cellulose acetates have at least 2 anhydroglucose rings and can have between at least 50 and up to 500 anhydroglucose rings, or at least 50 and less than 150 anhydroglucose rings. The number of anhydroglucose units per molecule is defined as the degree of polymerization (DP) of the cellulose acetate. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In embodiments, cellulose acetates useful herein can have a DS/AGU of about 2.2 to about 2.6, and the substituting ester is acetyl.

Cellulose acetates can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose acetates, can be obtained in different grades and sources such as from cotton linters, softwood pulp, hardwood pulp, corn fiber and other agricultural sources, and bacterial cellulose, among others.

One method of producing cellulose acetates is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substitutents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LICI/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substitutents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In embodiments, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose acetates useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ FE700.

In embodiments of the invention, the cellulose acetate can be prepared by converting cellulose to a cellulose ester with reactants that are obtained from recycled materials, e.g., a recycled plastic content syngas source. In embodiments, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose acetate composition comprising at least one recycle cellulose acetate is provided, wherein the cellulose acetate has at least one substituent on an anhydroglucose unit (AU) derived from recycled content material, e.g., recycled plastic content syngas.

The present application discloses a biodegradable cellulose acetate foam comprising biodegradable particulate natural fillers, wherein the foam has a density of from 0.04 to 0.6 g/cm³, an average foam cell size between 20 μm to 600 μm.

In one embodiment or in combination with any of the embodiments mentioned herein, the foam has a density of from 0.04 to 0.6 g/cm³, or 0.04 to 0.5 g/cm³, or 0.04 to 0.4 g/cm³, or 0.04 to 0.3 g/cm³, or 0.04 to 0.2 g/cm³, or 0.04 to 0.1 g/cm³, or 0.06 to 0.6 g/cm³, or 0.06 to 0.5 g/cm³, or 0.06 to 0.4 g/cm³, or 0.06 to 0.3 g/cm³, or 0.06 to 0.2 g/cm³, or 0.06 to 0.1 g/cm³, or 0.08 to 0.6 g/cm³, or 0.08 to 0.5 g/cm³, or 0.08 to 0.4 g/cm³, or 0.08 to 0.3 g/cm³, or 0.08 to 0.2 g/cm³, or 0.08 to 0.1 g/cm³, or 0.1 to 0.6 g/cm³, or 0.1 to 0.5 g/cm³, or 0.1 to 0.4 g/cm³, or 0.1 to 0.3 g/cm³, or 0.1 to 0.2 g/cm³, or 0.2 to 0.6 g/cm³, or 0.2 to 0.5 g/cm³, or 0.2 to 0.4 g/cm³, or 0.2 to 0.3 g/cm³, or 0.3 to 0.6 g/cm³, or 0.3 to 0.5 g/cm³, or 0.3 to 0.4 g/cm³, or 0.4 to 0.6 g/cm³, or 0.4 to 0.5 g/cm³, or 0.5 to 0.6 g/cm³.

In one embodiment or in combination with any of the embodiments mentioned herein, the average foam cell size is from 40 μm to 600 μm, or 50 μm to 600 μm, or 60 μm to 600 μm, or 70 μm to 600 μm, or 80 μm to 600μ m, or 90 μm to 600 μm, or 100 μm to 600 μm, or 150 μm to 600 μm, or 200 μm to 600 μm, or 250 μm to 600 μm, or 300 μm to 600 μm, or 400 μm to 600 μm, or 500 μm to 600 μm, or 40 μm to 550 μm, or 40 μm to 500 μm, or 40 μm to 450 μm, or 40 μm to 400 μm, or 40 μm to 350 μm, or 40 μm to 300 μm, or 40 μm to 250 μm, or 40 μm to 200 μm, or 40 μm to 150 μm, or 40 μm to 100 μm.

In one embodiment or in combination with any of the embodiments mentioned herein, the foam is prepared from a composition comprising: (a) 30 to 92 wt % cellulose acetate; (b) 5 to 30 wt % of a plasticizer; (c) 3.0 to 40 wt % of at least one natural filler; and (d) 0.0 to 9 wt % of at least one physical blowing agent; wherein wt % is based on the total weight of all components of the composition.

In one embodiment or in combination with any of the embodiments mentioned herein, the cellulose acetate has a degree of substitution of acetyl (DSAc) in the range of from 2.2 to 2.6.

In one embodiment or in combination with any of the embodiments mentioned herein, the plasticizer comprises triacetin, triethyl citrate, or a polyethylene glycol having an average weight average molecular weight of from 300 to 1000 Da. In one class of this embodiment, the plasticizer comprises triacetin. In one class of this embodiment, the plasticizer comprises triethyl citrate. In one class of this embodiment, the plasticizer comprises a polyethylene glycol having an average weight average molecular weight of from 300 to 1000 Da. In one subclass of this class the polyethylene glycol has an average weight average molecular weight of from 300 to 500 Da. In one subclass of this class the polyethylene glycol has an average weight average molecular weight of 400 Da.

In one embodiment or in combination with any of the embodiments mentioned herein, the natural filler is a biodegradable particulate material derived from a renewable organic source. Examples of natural fillers include but are not limited to pecan shell flour, walnut shell flour, wood flour, corn cob flour, rice hull flour, oat fiber powder, or combinations thereof.

In one embodiment or in combination with any of the embodiments mentioned herein, the foamable composition further comprises an inorganic physical nucleating agent.

In one embodiment or in combination with any of the embodiments mentioned herein, the foamable composition further comprises no inorganic physical nucleating agent.

In one embodiment or in combination with any of the embodiments mentioned herein, the composition further comprises a second physical blowing agent chosen from ((C₁₋₃)alkyl)₂O, CO₂, N₂, a ((C₁₋₃)alkyl) 2CO, (C₁₋₆)alkanol, (C₄₋₆)alkene, or combinations thereof. In one class of this embodiment the second physical blowing agent is ((C₁₋₃)alkyl) 20. In one class of this embodiment the second physical blowing agent is CO₂. In one class of this embodiment the second physical blowing agent is N₂. In one class of this embodiment the second physical blowing agent is a ((C₁₋₃)alkyl) 2CO. In one class of this embodiment the second physical blowing agent is (C₁₋₆)alkanol. In one class of this embodiment the second physical blowing agent is an (C₄₋₆)alkene.

In one embodiment or in combination with any of the embodiments mentioned herein, the second physical blowing agent is present from 0.2 to 3 wt %, or 0.2 to 2.5 wt %, or 0.2 to 2 wt %, or 0.2 to 1.5 wt %, or 0.2 to 1 wt %, or 0.2 to 0.5 wt %, or 0.5 to 3 wt %, or 0.5 to 2.5 wt %, or 0.5 to 2 wt %, or 0.5 to 1.5 wt %, or 0.5 to 1 wt %, or 1 to 3 wt %, or 1 to 2.5 wt %, or 1 to 2 wt %, or 1 to 1.5 wt %, or 1.5 to 3 wt %, or 1.5 to 2.5 wt %, or 1.5 to 2 wt %, or 2 to 3 wt %.

In one embodiment or in combination with any of the embodiments mentioned herein, the plasticizer comprises triacetin, triethyl citrate, or a polyethylene glycol having an average weight average molecular weight of from 300 to 1000 Da. In one class of this embodiment, the plasticizer comprises triacetin. In one class of this embodiment, the plasticizer comprises triethyl citrate. In one class of this embodiment, the plasticizer comprises a polyethylene glycol having an average weight average molecular weight of from 300 to 1000 Da. In one subclass of this class the polyethylene glycol has an average weight average molecular weight of from 300 to 500 Da. In one subclass of this class the polyethylene glycol has an average weight average molecular weight of 400 Da.

In one embodiment or in combination with any of the embodiments mentioned herein, the inorganic physical nucleating agent comprises a particulate composition with a median particle size of less than 2 microns. In one class of this embodiment, the physical nucleating agent comprises a particulate composition with a median particle size of from 0.1 to 2 microns. In one class of this embodiment, the physical nucleating agent comprises a particulate composition with a median particle size of from 0.5 to 2 microns. In one class of this embodiment, the physical nucleating agent comprises a particulate composition with a median particle size of from 1 to 2 microns.

In one embodiment or in combination with any of the embodiments mentioned herein, the inorganic physical nucleating agent comprises a magnesium silicate, a silicon dioxide, a magnesium oxide or combinations thereof.

In one embodiment or in combination with any of the embodiments mentioned herein, the organic physical nucleating agent comprises a biodegradable particulate natural filler having a maximum particle size of less than or equal to 600 microns. In one class of this embodiment, the organic physical nucleating agent comprises a biodegradable particulate natural filler having a maximum particle size of less than or equal to 250 microns. In one class of this embodiment, the organic physical nucleating agent comprises a biodegradable particulate natural filler having a maximum particle size of less than or equal to 180 microns. In one class of this embodiment, the organic physical nucleating agent comprises a biodegradable particulate natural filler having a maximum particle size of less than or equal to 150 microns. In one class of this embodiment, the organic physical nucleating agent comprises a biodegradable particulate natural filler having a maximum particle size of less than or equal to 75 microns. In one class of this embodiment, the organic physical nucleating agent comprises a biodegradable particulate natural filler having a maximum particle size of less than or equal to 60 microns.

In one embodiment or in combination with any of the embodiments mentioned herein, the organic physical nucleating agent comprises a biodegradable particulate natural filler. Examples of biodegradable particulate natural fillers include but are not limited to pecan shell flour, walnut flour, wood flour, corn cob flour, rice hull flour, oat fiber powder, or combinations thereof.

In one embodiment or in combination with any of the embodiments mentioned herein, the foam, composition or foamable composition comprises two or more cellulose acetates having different degrees of substitution of acetyl.

In one embodiment or in combination with any of the embodiments mentioned herein, the first physical blowing agent is present at from 1.3 to 1.5 wt %, or 1.3 to 2.0 wt %, or 1.3 to 2.5 wt %, or 1.3 to 3.0 wt %, or 1.3 to 3.5 wt %, or 1.3 to 4.0 wt %, or 1.3 to 4.5 wt %, or 1.3 to 5.0 wt %, or 1.3 to 5.5 wt %, or 1.5 to 3.0 wt %, or 1.5 to 4.0 wt %, or 1.5 to 5.0 wt %, or 1.5 to 6.0 wt %, or 2.0 to 3.0 wt %, or 2.0 to 4.0 wt %, or 2.0 to 5.0 wt %, or 2.0 to 6.0 wt %, or 2.5 to 3.0 wt %, or 2.5 to 4.0 wt %, or 2.5 to 5.0 wt %, or 2.5 to 6.0 wt %, or 3.0 to 4.0 wt %, or 3.0 to 5.0 wt %, or 3.0 to 6.0 wt %, or 0.0 to 9.0 wt %, or 0.5 to 9.0 wt %, or 1.0 to 9.0 wt %, or 1.5 to 9.0 wt %, or 2.0 to 9.0 wt %, or 2.5 to 9.0 wt %, or 3.0 to 9.0 wt %, or 3.5 to 9.0 wt %, or 4.0 to 9.0 wt %, or 4.5 to 9.0 wt %, or 5.0 to 9.0 wt %, or 5.5 to 9.0 wt %, or 6.0 to 9.0 wt %, or 6.5 to 9.0 wt %, or 7.0 to 9.0 wt %, or 7.5 to 9.0 wt %, or 8.0 to 9.0 wt %, or 8.5 to 9.0 wt %.

In one embodiment or in combination with any of the embodiments mentioned herein, the physical nucleating agent is present at from 0.1 to 2.5 wt %, or 0.1 to 2.0 wt %, or 0.1 to 1.5 wt %, or 0.1 to 1.0 wt %, or 0.1 to 0.5 wt %, or 0.1 to 5.0 wt %, or 0.1 to 10.0 wt %, or 0.1 to 20.0 wt %, or 0.1 to 30.0 wt %, or 0.1 to 40.0 wt %, or 0.2 to 3.0 wt %, or 0.2 to 2.5 wt %, or 0.2 to 2.0 wt %, or 0.2 to 1.5 wt %, or 0.2 to 1.0 wt %, or 0.2 to 0.5 wt %, or 0.5 to 2.5 wt %, or 0.5 to 2.0 wt %, or 0.5 to 1.5 wt %, 0.5 to 1.0 wt %, or 1.0 to 6.0 wt %, or 1.0 to 5.5 wt %, or 1.0 to 5.0 wt %, 1.0 to 4.5 wt %, or 1.0 to 4.0 wt %, or 1.0 to 3.5 wt %, or 1.0 to 3.0 wt %, or 1.0 to 2.5 wt %, or 1.0 to 2.0 wt %, or 1.0 to 1.5 wt %, or 1.5 to 6.0 wt %, or 1.5 to 5.5 wt %, or 1.5 to 5.0 wt %, or 1.5 to 4.5 wt %, or 1.5 to 4.0 wt %, or 1.5 to 3.5 wt %, or 1.5 to 3.0 wt %, or 1.5 to 2.5 wt %, or 1.5 to 2.0 wt %, or 2.0 to 6.0 wt %, or 2.0 to 5.5 wt %, or 2.0 to 5.0 wt %, or 2.0 to 4.5 wt %, or 2.0 to 4.0 wt %, or 2.0 to 3.5 wt %, or 2.0 to 3.0 wt %, or 2.0 to 2.5 wt %, or 2.5 to 6.0 wt %, or 2.5 to 5.5 wt %, or 2.5 to 5.0 wt %, or 2.5 to 4.5 wt %, or 2.5 to 4.0 wt %, or 2.5 to 3.5 wt %, or 2.5 to 3.0 wt %, or 3.0 to 6.0 wt %, or 3.0 to 5.5 wt %, or 3.0 to 5.0 wt %, or 3.0 to 4.5 wt %, or 3.0 to 4.0 wt %, or 3.0 to 3.5 wt %, or 3.5 to 6.0 wt %, or 3.5 to 5.5 wt %, or 3.5 to 5.0 wt %, or 3.5 to 4.5 wt %, or 3.5 to 4.0 wt %, or 4.0 to 6.0 wt %, or 4.0 to 5.5 wt %, or 4.0 to 5.0 wt %, or 4.0 to 4.5 wt %, or 4.5 to 6.0 wt %, or 4.5 to 5.5 wt %, or 4.5 to 5.0 wt %.

In one embodiment or in combination with any of the embodiments mentioned herein, the plasticizer is present at from 5 to 30 wt %, or 5 to 25 wt %, or 5 to 20 wt %, or 5 to 15 wt % or 5 to 10 wt %, or 6 to 30 wt %, or 6 to 25 wt %, or 6 to 20 wt %, or 6 to 15 wt %, or 6 to 10 wt %, or 7 to 30 wt %, or 7 to 25 wt %, or 7 to 20 wt %, or 7 to 15 wt %, or 7 to 10 wt %, or 8 to 30 wt %, or 8 to 25 wt %, or 8 to 20 wt %, or 8 to 15 wt %, or 8 to 10 wt %, or 9 to 30 wt %, or 9 to 25 wt %, or 9 to 20 wt %, or 8 to 15 wt %, or 9 to 30 wt %, or 9 to 25 wt %, or 9 to 20 wt %, or 9 to 15 wt %, or 10 to 30 wt %, or 10 to 25 wt %, or 10 to 20 wt %, or 10 to 15 wt %, or 15 to 30 wt %, or 15 to 25 wt %, or 15 to 20 wt %, or 20 to 30 wt %, or 20 to 25 wt %.

In one embodiment or in combination with any of the embodiments mentioned herein, the foamable composition can be in the form of a pellet or a powder.

The present application discloses an article prepared from any of the mentioned biodegradable cellulose acetate foams or compositions disclosed herein.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

In one embodiment or in combination with any of the embodiments mentioned herein, the biodegradable cellulose acetate foam or article is industrial compostable or home compostable. In one subclass of this class, the foam or article is industrial compostable. In one sub-subclass of this subclass, the foam or article has a thickness that is less than 6 mm. In one sub-subclass of this subclass, the foam or article has a thickness that is less than 3 mm. In one sub-subclass of this subclass, the article has a thickness that is less than 1.1 mm. In one subclass of this class, the foam or article is home compostable. In one sub-subclass of this subclass, the foam or article has a thickness that is less than 6 mm. In one sub-subclass of this subclass, the foam or article has a thickness that is less than 3 mm. In one sub-subclass of this subclass, the foam or article has a thickness that is less than 1.1 mm. In one sub-subclass of this subclass, the foam or article has a thickness that is less than 0.8 mm. In one sub-subclass of this subclass, the foam or article has a thickness that is less than 0.6 mm. In one sub-subclass of this subclass, the foam or article has a thickness that is less than 0.4 mm.

In one embodiment or in combination with any of the embodiments mentioned herein, the thickness of the foam or article is less than 3 mm.

In one embodiment or in combination with any of the embodiments mentioned herein, the foam or article exhibits greater than 90% disintegration after 12 weeks according to the disintegration test protocol for films, as described in the specification.

The compositions used to prepare the biodegradable cellulose acetate foams can comprise other additives such as fillers, stabilizers, odor modifiers, waxes, compatibilizers, biodegradation promoters, dyes, pigments, colorants, lubricants, anti-oxidants, viscosity modifiers, antifungal agents, heat stabilizers, antibacterial agents, softening agents, mold release agents, and combinations thereof. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment mentioned herein, the foam, composition or foamable composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment mentioned herein, the foam, composition, or foamable composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide. In one subclass of this class, the pigment is a biodegradable particulate natural filler.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

In one embodiment or in combination with any other embodiment, the foam or article exhibits greater than 30% disintegration after 12 weeks according to Disintegration Test Protocol, as described in the specification or in the alternative according to ISO 16929 (2013). In one embodiment or in combination with any other embodiment, the foam or article exhibits greater than 50% disintegration after 12 weeks according to Disintegration Test Protocol, as described in the specification or in the alternative according to ISO 16929 (2013). In one embodiment or in combination with any other embodiment, the foam or article exhibits greater than 70% disintegration after 12 weeks according to Disintegration Test Protocol, as described in the specification or in the alternative according to ISO 16929 (2013). In one embodiment or in combination with any other embodiment, the foam or article exhibits greater than 80% disintegration after 12 weeks according to Disintegration Test Protocol, as described in the specification or in the alternative according to ISO 16929 (2013). In one embodiment or in combination with any other embodiment, the foam or article exhibits greater than 90% disintegration after 12 weeks according to Disintegration Test Protocol, as described in the specification or in the alternative according to ISO 16929 (2013). In one embodiment or in combination with any other embodiment, the foam or article exhibits greater than 95% disintegration after 12 weeks according to Disintegration Test Protocol, as described in the specification or in the alternative according to ISO 16929 (2013).

### Examples

For the examples herein, test methods, abbreviations, and materials are as follows:

Color is reported in terms of CIE color space L* a* b* values as measured by using a Chroma meter (Konica Minolta CR-400). Color is expressed in terms of L* where 0=black and 100=white; a* where negative values indicate greenness, positive values indicate redness; b* where negative values indicate blueness and positive values indicate yellowness. To measure the color of the film samples, a piece of 10 mil film was placed against a white cardboard as the background. To measure the color of the filler samples, an amount of filler sufficient to prevent seeing through the microscope slide was sandwiched between the microscope slide and a cover slide.

Particle Size is reported in microns as an upper limit (does not exceed) particle size based on standard US Mesh Size.

Film Thickness is determined by the thickness of the frame used to compression mold the film samples. Frames used were either 254 micron (10 mil) or 508 micron (20 mil) in thickness.

Tensile properties are measured according to ASTM-D638 on an Instron tensile testing frame. Break Stress and Young's Modulus are reported in MPa, Break Strain is reported in %, and Energy at Break is reported in N/mm².

Density is measured by the water displacement method wherein the mass (g) of a foam sample approximately 1 cm×3 cm is recorded prior to submerging the sample in water and recording the volume (cm³) of water displaced. Density is calculated by dividing the mass by the volume.

Cell Size is determined by using a scanning electron microscope to capture a cross sectional image of the foam sample prepared via microtome at 90′ to the face of the sample at 1000× magnification. Digital image analysis software (ImageJ) is then used to measure the diameters of at least 10 randomly selected cells. The average of the measured diameters is recorded as sample cell size.

Weight % may be abbreviated as wt % and, unless otherwise indicated, is based on the weight of all other components in the formulation (both solid and liquid).

### Cellulose Acetate (CA)

CA1: CA-398-30 (39.7 wt % acetyl); commercially available from Eastman Chemical Company
CA 2: Cellulose Acetate FE700 (40 wt % acetyl); commercially available from Eastman Chemical Company

### Liquid Plasticizers

TEC—Triethyl citrate 98%-CAS Number 77-93-0; MW: 276.28; commercially available from Sigma Aldrich, product number 27500
TA—Triacetin-commercially available from Eastman Chemical Company

### Natural Fillers

NF1—Pecan Shell Flour-particle size: ≤74 μm (200 mesh); commercially available from Composition Materials Co., Inc.
NF2—Walnut Shell Flour-particle size: ≤149 μm (100 mesh); commercially available from Composition Materials Co., Inc.
NF3—Wood Flour 30/60-particle size: 50%≤600 μm (30 mesh) and 50%≤250 μm (60 mesh); commercially available from Composition Materials Co., Inc.
NF4—Wood Flour 60-particle size: ≤250 μm (60 mesh); commercially available from Composition Materials Co., Inc.
NF5—Corn Cob Bio Filler-particle size: ≤177 μm (80 mesh); commercially available from Composition Materials Co., Inc.
NF6—Rice Hull Bio Filler-particle size: ≤177 μm (80 mesh); commercially available from Composition Materials Co., Inc.
NF7—Oat Fiber Powder-particle size: ≤57 μm; commercially available from NuNatural.
NF8—Hemp Fiber-fiber length: up to 6 mm Inorganic Physical Nucleating Agent (IPNA)
Talc—Talc ABT 1000; commercially available from Specialty Minerals

### Melt Processing Protocol for CA Films/Foam Pre-Forms

Compounded pellets were formed from CA powder, liquid plasticizer, natural fillers, and optionally an inorganic physical nucleating agent. The dry ingredients were bag blended into a free-flowing powder which was fed to an 18 mm (Leistritz) twin screw extruder with a single-hole die. The liquid plasticizer was fed into zone 2 of the extruder via a liquid injection unit supplied by a Witte gear pump, controlled by a Hardy 4060 controller, through an injector with a 0.020 inch bore. The compounded strands were run through a water trough and pelletized with a ConAir pelletizer. The pellets were dried overnight at 70° C. under vacuum in a vacuum oven at 7-10 psi vacuum.

The dried pellets were subsequently converted into film samples using a compression molder (Pasadena Hydraulics Inc, PW-220-C-X1-4) and molding frames of either 254 micron (10 mil) or 508 micron (20 mil) thickness to compression mold the dried pellets into a film. Samples were molded at a temperature of 400′F (204.4° C.) for 90 seconds at 8,000-10,000 pounds ram force. The pressure is then released and reapplied at 20,000-22,000 pounds ram force for another 30 seconds. The pressure is released again and reapplied at 20,000-22,000 for a final 60 seconds.

### Foaming Protocol

Batch foaming of film samples was conducted in a 300 mL high pressure autoclave (Parr Instrument Company Model No. 4561) having a diameter of 2.5 inches and a depth of 4 inches. The autoclave was equipped with a thermocouple and a pressure sensor. The dip tube, agitator shaft, and impeller were removed. CA Film samples measuring 1 inch by 1 inch (films were either 10 or 20 mil thickness as indicated in Table 1) were placed on folded Teflon trays measuring 1.5 inch×1.5 inch×0.5 inch (L×W×H). The trays containing the film samples were stacked in a staggered fashion 3 or 4 high in the autoclave which was then closed, sealed, and heated to a desired temperature in the range of 150° C. to 230° C. Once the autoclave reached the desired temperature, the vessel was pressurized with CO₂ gas to a desired pressure in the range of 50 bar to 130 bar and the autoclave was allowed to stabilize at the target temperature and pressure. After stabilization, the CA film samples were held at target temperature and pressure for 30 minutes to allow for CO₂ gas penetration into the films. After 30 minutes at target temperature and pressure, a ¼ inch vent valve was opened and the autoclave was purged with nitrogen gas. The rapid pressure release caused the film samples to expand into foam. After the autoclave cooled to room temperature, the foam samples were retrieved and analyzed for density (g/cm³) and cell size (nm).

TABLE 1
Sample Formulations and Processing Conditions

| | | | | | | | Film | Foaming | Foaming |
|---|---|---|---|---|---|---|---|---|---|
| | CA | PZ | | Filler | | Talc | Thickness | Temp | Pressure |
| Sample | (wt %) | (wt %) | | (wt %) | | (wt %) | (mil) | (° C.) | (bar) |
| 1 | CA2 (85) | TEC | (15) | N/A | | 0 | 508 | N/A | N/A |
| 2 | CA2 (75) | TEC | (15) | NF1 | (10) | 0 | 508 | N/A | N/A |
| 3 | CA2 (75) | TEC | (15) | NF2 | (10) | 0 | 508 | N/A | N/A |
| 4 | CA2 (75) | TEC | (15) | NF3 | (10) | 0 | 508 | N/A | N/A |
| 5 | CA2 (75) | TEC | (15) | NF4 | (10) | 0 | 508 | N/A | N/A |
| 6 | CA2 (75) | TEC | (15) | NF5 | (10) | 0 | 508 | N/A | N/A |
| 7 | CA2 (75) | TEC | (15) | NF6 | (10) | 0 | 508 | N/A | N/A |
| 8 | CA2 (75) | TEC | (15) | NF7 | (10) | 0 | 508 | N/A | N/A |
| 9 | CA2 (75) | TEC | (15) | NF2 | (10) | 0 | 508 | N/A | N/A |
| 10 | CA2 (75) | TEC | (15) | NF1 | (10) | 0 | 508 | N/A | N/A |
| 11 | CA2 (75) | TEC | (15) | NF5 | (10) | 0 | 508 | N/A | N/A |
| 12 | CA2 (75) | TEC | (15) | NF6 | (10) | 0 | 508 | N/A | N/A |
| 13 | CA2 (75) | TEC | (15) | NF3 | (10) | 0 | 508 | N/A | N/A |
| 14 | CA2 (75) | TEC | (15) | NF4 | (10) | 0 | 508 | N/A | N/A |
| 15 | CA2 (75) | TEC | (15) | NF7 | (10) | 0 | 508 | N/A | N/A |
| 16 | CA2 (75) | TEC | (15) | NF8 | (10) | 0 | 508 | N/A | N/A |
| 17 | CA2 (74) | TA | (15) | NF1 | (10) | 1 | 254 | 200 | 130 |
| 18 | CA2 (74) | TA | (15) | NF6 | (10) | 1 | 254 | 200 | 130 |
| 19 | CA2 (74) | TA | (15) | NF5 | (10) | 1 | 254 | 200 | 130 |
| 20 | CA2 (74) | TA | (15) | NF3 | (10) | 1 | 254 | 200 | 130 |
| 21 | CA2 (74) | TA | (15) | NF7 | (10) | 1 | 254 | 200 | 130 |
| 22 | CA2 (74) | TA | (15) | NF2 | (10) | 1 | 254 | 200 | 130 |
| 23 | CA2 (74) | TEC | (15) | NF5 | (5) | 1 | 254 | 200 | 130 |
| 24 | CA2 (74) | TEC | (15) | NF5 | (10) | 1 | 254 | 200 | 130 |
| 25 | CA2 (75) | TA | (15) | NF7 | (10) | 0 | 508 | 205 | 100 |
| 26 | CA2 (75) | TA | (15) | NF7 | (20) | 0 | 508 | 205 | 100 |
| 27 | CA2 (75) | TA | (15) | NF7 | (30) | 0 | 508 | 205 | 100 |
| 28 | CA2 (75) | TA | (15) | NF7 | (40) | 0 | 508 | 205 | 100 |
| 29 | CA2 (75) | TA | (15) | NF3 | (10) | 0 | 508 | 205 | 100 |
| 30 | CA2 (75) | TA | (15) | NF3 | (30) | 0 | 508 | 205 | 100 |
| 31 | CA2 (75) | TA | (15) | NF7 | (10) | 0 | 508 | 205 | 130 |
| 32 | CA2 (75) | TA | (15) | NF7 | (20) | 0 | 508 | 205 | 130 |
| 33 | CA2 (75) | TA | (15) | NF7 | (30) | 0 | 508 | 205 | 130 |
| 34 | CA2 (75) | TA | (15) | NF7 | (40) | 0 | 508 | 205 | 130 |
| 35 | CA2 (75) | TA | (15) | NF3 | (10) | 0 | 508 | 205 | 130 |
| 36 | CA2 (75) | TA | (15) | NF3 | (30) | 0 | 508 | 205 | 130 |
| 37 | CA2 (75) | TA | (15) | NF4 | (7.5) | 0 | 508 | 205 | 130 |
| 38 | CA2 (75) | TA | (15) | NF4 | (15) | 0 | 508 | 205 | 130 |
| 39 | CA2 (75) | TA | (15) | NF5 | (10) | 0 | 508 | 205 | 130 |
| 40 | CA2 (74) | TA | (15) | NF7 | (10) | 1 | 508 | 205 | 130 |
| 41 | CA2 (74) | TA | (15) | NF7 | (10) | 1 | 508 | 205 | 130 |
| 42 | CA2 (82) | TA | (15) | NF4 | (3) | 0 | 508 | 205 | 50 |
| 43 | CA2 (81) | TA | (15) | NF4 | (3) | 1 | 508 | 205 | 50 |
| 44 | CA2 (82) | TA | (15) | NF3 | (3) | 0 | 508 | 205 | 50 |
| 45 | CA2 (81) | TA | (15) | NF3 | (3) | 1 | 508 | 205 | 50 |
| 46 | CA2 (82) | TA | (15) | NF7 | (3) | 0 | 508 | 205 | 50 |
| 47 | CA2 (81) | TA | (15) | NF7 | (3) | 1 | 508 | 205 | 50 |
| 48 | CA2 (82) | TA | (15) | NF4 | (3) | 0 | 508 | 205 | 70 |
| 49 | CA2 (81) | TA | (15) | NF4 | (3) | 1 | 508 | 205 | 70 |
| 50 | CA2 (82) | TA | (15) | NF3 | (3) | 0 | 508 | 205 | 70 |
| 51 | CA2 (81) | TA | (15) | NF3 | (3) | 1 | 508 | 205 | 70 |
| 52 | CA2 (82) | TA | (15) | NF7 | (3) | 0 | 508 | 205 | 70 |
| 53 | CA2 (81) | TA | (15) | NF7 | (3) | 1 | 508 | 205 | 70 |
| 54 | CA2 (82) | TA | (15) | NF4 | (3) | 0 | 508 | 205 | 100 |
| 55 | CA2 (81) | TA | (15) | NF4 | (3) | 1 | 508 | 205 | 100 |
| 56 | CA2 (82) | TA | (15) | NF3 | (3) | 0 | 508 | 205 | 100 |
| 57 | CA2 (81) | TA | (15) | NF3 | (3) | 1 | 508 | 205 | 100 |
| 58 | CA2 (82) | TA | (15) | NF7 | (3) | 0 | 508 | 205 | 100 |
| 59 | CA2 (81) | TA | (15) | NF7 | (3) | 1 | 508 | 205 | 100 |
| 60 | CA2 (82) | TA | (15) | NF4 | (3) | 0 | 508 | 205 | 130 |
| 61 | CA2 (81) | TA | (15) | NF4 | (3) | 1 | 508 | 205 | 130 |
| 62 | CA2 (82) | TA | (15) | NF3 | (3) | 0 | 508 | 205 | 130 |
| 63 | CA2 (81) | TA | (15) | NF3 | (3) | 1 | 508 | 205 | 130 |
| 64 | CA2 (82) | TA | (15) | NF7 | (3) | 0 | 508 | 205 | 130 |
| 65 | CA2 (81) | TA | (15) | NF7 | (3) | 1 | 508 | 205 | 130 |

| | | | | | | | | |
|---|---|---|---|---|---|---|---|---|
| 66 | CA2 (84) | TA | (15) | N/A | 1 | 508 | 205 | 130 |

### Example 1-Fillers as Natural Color Additives

Samples of Natural fillers were evaluated for color. Natural fillers evaluated included Pecan Shell Flour (NF1); Walnut Shell Flour (NF2); Wood Flour 30/60 (NF3); Wood Flour 60 (NF4); Corn Cob Flour (NF5); Rice Hull Flour (NF6); and Oat Fiber Powder (NF7). Following the above melt processing protocol, film samples of 508 micron thickness were produced according to the formulations recited in Table 1, samples 1-8. The resulting films were analyzed for color. Table 2 summarizes the L*, a*, and b* values measured by the chroma meter.

TABLE 2
Color analysis of Natural Filler materials and CA films
having 10% loading of Natural Filler materials

| | Natural | Filler | | | Film | | |
|---|---|---|---|---|---|---|---|
| Sample | Filler | L* | a* | b* | L* | a* | b* |
| 1 | None | NA | NA | NA | 92.33 | 0.20 | 1.40 |
| 2 | NF1 | 62.16 | 8.78 | 20.05 | 40.24 | 17.5 | 22.60 |
| 3 | NF2 | 66.43 | 5.02 | 18.79 | 45.13 | 13.6 | 24.09 |
| 4 | NF3 | 73.36 | 3.50 | 19.61 | 74.19 | 2.87 | 18.76 |
| 5 | NF4 | 73.68 | 4.70 | 18.44 | 71.42 | 5.37 | 22.61 |
| 6 | NF5 | 72.26 | 3.83 | 9.23 | 67.39 | 5.83 | 28.43 |
| 7 | NF6 | 70.08 | 0.98 | 14.37 | 56.31 | 4.80 | 28.61 |
| 8 | NF7 | 82.25 | 1.00 | 18.06 | 78.82 | 0.75 | 29.59 |

As seen in Table 2, all filler and film samples exhibit positive a* values, indicating a red tone as well as positive b* values indicating a yellow tone. For most films, the colors became more accentuated as indicated by the higher a* and b* values. After melt processing, the film samples generally exhibited lower L* values indicating darker color than the fillers exhibited prior to melt processing. The film of Sample 4 (NF3), which did not appear darker (lower L*) or have higher a* and b* values exhibited significant agglomeration of the filler resulting in a speckled appearance with significant areas of light and dark color which likely contributed to the nonconforming color result for this sample. Samples 1-8 demonstrate that incorporating natural fillers into a CA film is an effective means to generate CA films and foam/foamed articles having natural colors, which one cannot obtain with the commercially prevalent compositions utilizing polystyrene, plasticizer, and talc. The natural appearance of the foam products of Samples 2-8 is the result of the use natural fillers and is desirable because it is easily distinguishable from articles made from non-biodegradeable white polystyrene based styrofoam.

### Example 2-Tensile Properties of CA Films Containing Natural Fillers

Pellets were compounded and compression molded into film samples according to the above melt processing protocol and the formulations recited in Table 1, samples 9-16. The resulting 508 micron thickness films were conditioned at 25° C. and 50% RH for 48 hours then tested for tensile properties according to ASTM-D638.

TABLE 3
Tensile properties of 508 micron thickness
films containing 10% natural fillers

| | | | | Young's | Energy @ |
|---|---|---|---|---|---|
| | | Break Stress | Break Strain | Modulus | Break |
| Sample | Filler | (MPa) | (%) | (MPa) | (N/mm²) |
| 9 | NF1 | 46.4 | 2.4 | 2636.4 | 0.68 |
| 10 | NF2 | 44.9 | 4.2 | 2493.2 | 1.5 |
| 11 | NF5 | 44.3 | 2.6 | 2517 | 0.71 |
| 12 | NF6 | 43.1 | 2.3 | 2567 | 0.62 |
| 13 | NF3 | 44.4 | 2.2 | 2603.8 | 0.6 |
| 14 | NF4 | 47.4 | 2.5 | 2587.9 | 0.73 |
| 15 | NF7 | 47.3 | 2.7 | 2578 | 0.81 |
| 16 | NF8 | 42.2 | 1.9 | 2666.7 | 0.47 |

Break stress and Young's Modulus tended to decrease as the maximum particle size of the natural filler increased while breaking strain and energy at break appeared to be unaffected by particle size. Comparing the particulate fillers (Samples 9-15) to the hemp fiber filler (Sample 16), films with the particulate natural fillers appeared to be more ductile, exhibiting higher strain at break and energy at break.

### Example 3—Batch Foaming of CA Films with Natural Fillers and Talc

Pellets were compounded and compression molded into films of 254 micron thickness according to the above melt processing protocol and the formulations recited in Table 1, samples 17-24.

Batch foaming of the film samples was conducted according to the above foaming protocol using a pressure of 130 bar and a temperature of 200° C. The density and cell size of the foam samples were measured and the resulting densities and cell sizes are summarized below in Table 4.

TABLE 4
Density and Cell Size of CA Foams
with Natural Fillers and 1% Talc

| | Filler | PZ | Talc | Density | Cell Size |
|---|---|---|---|---|---|
| Sample | (wt %) | (wt %) | (wt %) | (g/cm³) | (nm) |
| 17 | NF1 (10) | TA (15) | 1 | 0.227 | 32 ± 4 |
| 18 | NF6 (10) | TA (15) | 1 | 0.180 | 99 ± 18 |
| 19 | NF5 (10) | TA (15) | 1 | 0.226 | 31 ± 5 |
| 20 | NF3 (10) | TA (15) | 1 | 0.231 | 59 ± 19 |
| 21 | NF7 (10) | TA (15) | 1 | 0.214 | 53 ± 9 |
| 22 | NF2 (10) | TA (15) | 1 | 0.209 | 50 ± 14 |
| 23 | NF5 (5) | TEC (15) | 1 | 0.239 | 80 ± 21 |
| 24 | NF5 (10) | TEC (15) | 1 | 0.240 | 70 ± 23 |

These results demonstrate that cellulose acetate compositions containing various types of natural fillers and talc can be converted into cellulose acetate foam samples that exhibit densities and cell sizes which are useful across many low density foam product applications.

### Example 4—Talc-Free Foam Formulations Having High Natural Filler Content

Films containing various types of natural fillers and no inorganic physical nucleating agent were prepared according to the above melt processing protocol and the formulations recited in Table 1, samples 25-39. The resulting film samples were foamed according to the foaming protocol at the pressures and temperatures recited in Table 1. None of the samples contained inorganic physical nucleating agent. The density and cell size of the foam samples were measured and the resulting densities and cell sizes are summarized below in Table 5.

TABLE 5
Foams Having High Natural Filler Loadings
and no Inorganic Physical Nucleating Agent

| | Foaming | | | |
|---|---|---|---|---|
| | Pressure | Filler | Density | Cell Size |
| Sample | (Bar) | (wt %) | (g/cm³) | (nm) |
| 25 | 100 | NF7 (10) | 0.174 | 49 ± 19 |
| 26 | 100 | NF7 (20) | 0.158 | 53 ± 11 |
| 27 | 100 | NF7 (30) | 0.213 | 67 ± 11 |
| 28 | 100 | NF7 (40) | 0.563* | 97 ± 51 |
| 29 | 100 | NF3 (10) | 0.199 | 46 ± 16 |
| 30 | 100 | NF3 (30) | 0.378 | 35 ± 15 |
| 31 | 130 | NF7 (10) | 0.144 | 68 ± 13 |
| 32 | 130 | NF7 (20) | 0.259 | 41 ± 6 |
| 33 | 130 | NF7 (30) | 0.547* | 30 ± 7 |
| 34 | 130 | NF7 (40) | 0.556* | 27 ± 7 |
| 35 | 130 | NF3 (10) | 0.191 | 59 ± 6 |
| 36 | 130 | NF3 (30) | 0.305 | 49 ± 5 |
| 37 | 130 | NF4 (7.5) | 0.078 | 163 ± 128 |
| 38 | 130 | NF4 (15) | 0.226 | 120 ± 34 |
| 39 | 130 | NF5 (10) | 0.263 | 46 ± 5 |

*Samples exhibited densities appropriate for medium density foam applications

Natural fillers not only modify the appearance of the cellulose acetate composition as well as the resulting foam, but they also act as physical nucleating agents, negating the need for inorganic physical nucleating agent such as talc. Additionally, low density foams can be produced having high loadings of natural fillers, lowering the overall raw material cost of the composition. For example, acceptable low density foams of less than 0.400 g/cm³ can be achieved with loading having up to 30% oat fiber powder or wood flour without utilizing any inorganic physical nucleating agent.

### Example 5—Natural Fillers Reducing CA Foam Density

Natural fillers are hygroscopic, and can be used as a carrier of water which acts as a physical blowing agent during foaming, to reduce foam density.

To evaluate the equilibrium moisture uptake of natural fillers, samples of each natural filler material were dried under vacuum overnight. The samples were weighed after drying and the % weight loss was attributed as the equilibrium moisture content of the material. Each sample of dried natural filler was then placed into individual small vials which were then each placed in a larger jar containing some water. The large jars were then sealed and conditioned in an oven at either 25° C. or 70° C. overnight. The conditioned natural filler samples were weighed again, and the moisture uptake values are shown in Table 6 below.

TABLE 6
Moisture uptake of select natural fillers

| Filler | Filler | Equilibrium | 24 hr @ 25° C. | 24 hr @ 70° C. |
|---|---|---|---|---|
| I.D. | Material | Moisture | Moisture | Moisture |
| NF3 | Wood Flour | 6.6% | 6.4% | 17.8% |
| | 30/60 | | | |
| NF4 | Wood Flour | 8.2% | 6.7% | 22.1% |
| | 60 | | | |
| NF5 | Corn Cob | 8.1% | 3.1% | 22.0% |
| | Flour | | | |
| NF6 | Rice Hull | 9.2% | 4.3% | 21.7% |
| | Flour | | | |
| NF7 | Oat Fiber | 4.8% | 4.6% | 13.8% |
| | Powder | | | |
| NF8 | Hemp Fiber | 8.4% | 10.3% | 17.7% |

The samples conditioned at ambient temperature (25° C.) returned to moisture contents that were similar to the originally measured equilibrium moisture. However, the samples conditioned at elevated temperature (70° C.) absorbed significantly more moisture.

To evaluate the effect of higher moisture content filler, CA film samples containing 10% NF7 were prepared according to the above melt processing protocol and the formulations recited in Table 1, samples 40-41. Batch foaming of the film samples was carried out according to the foaming protocol. The CA film of sample 40 (dry condition) was not conditioned prior to foaming while the CA film of sample 41 (wet condition) was placed in a small jar, which is then placed in a larger jar containing some water. The larger jar was then sealed and conditioned overnight at 70° C. prior to foaming.

TABLE 7
Density and Cell Size of Dry and Wet Conditioned CA Foams

| Sample | Condition | Filler (wt %) | Density (g/cm³) | Cell Size (nm) |
|---|---|---|---|---|
| 40 | Dry | NF7 (10) | 0.214 | 53 ± 9 |
| 41 | Wet | NF7 (10) | 0.180 | 81 ± 21 |

Table 7 demonstrates that pre-conditioning CA films containing hygroscopic natural fillers in a humid environment enables lower density foam having larger cell size. The film increases in moisture content as the natural fillers absorb moisture during conditioning and the absorbed moisture subsequently acts as a physical blowing agent to reduce the density of the foam.

### Example 6—Natural Fillers as an Alternative Nucleating Agent (Replacing Talc)

Films containing various types of natural fillers were prepared according to the above melt processing protocol and the formulations recited in Table 1, samples 42-66. The film samples were then batch foamed according to the foaming protocol and Table 1. The resulting foam samples were evaluated for density and cell size.

The talc free formulations of this example demonstrate that natural fillers can also function effectively as nucleating agents. At as low as 3% loading, several natural fillers demonstrated sufficient nucleation and foaming, resulting in low foam density and fine cell morphology. Foaming pressures of 100 and 130 bar appeared to be optimal conditions in generating low density foam without inorganic nucleator.

Additionally, natural fillers can be used in conjunction with talc to further reduce foam density, increase average cell size, and reduce the raw materials cost of a composition. At low foaming pressure (50 and 70 bar), the addition of 1 wt % talc increased foam density but reduced cell size for most samples. Surprisingly, at high foaming pressure (100 and 130 bar), the addition of 1 wt % talc substantially reduced foam density while increasing cell size.

TABLE 8
Comparison of foam density and cell size containing 3% natural
filler with and without nucleator at various pressures

| | Foaming | | | | | |
|---|---|---|---|---|---|---|
| | Pressure | Filler | PZ | Talc | Density | Cell Size |
| Sample | (Bar) | (wt %) | (wt %) | (Wt %) | (g/cm³) | (nm) |
| 42 | 50 | NF4 (3) | TA (15) | 0 | 0.075 | 427 ± 128 |
| 43 | 50 | NF4 (3) | TA (15) | 1 | 0.069 | 328 ± 68 |
| 44 | 50 | NF3 (3) | TA (15) | 0 | 0.053 | 412 ± 136 |
| 45 | 50 | NF3 (3) | TA (15) | 1 | 0.068 | 383 ± 101 |
| 46 | 50 | NF7 (3) | TA (15) | 0 | 0.074 | 440 ± 154 |
| 47 | 50 | NF7 (3) | TA (15) | 1 | 0.099 | 293 ± 113 |
| 48 | 70 | NF4 (3) | TA (15) | 0 | 0.059 | 174 ± 69 |
| 49 | 70 | NF4 (3) | TA (15) | 1 | 0.046 | 230 ± 67 |
| 50 | 70 | NF3 (3) | TA (15) | 0 | 0.050 | 273 ± 69 |
| 51 | 70 | NF3 (3) | TA (15) | 1 | 0.054 | 243 ± 43 |
| 52 | 70 | NF7 (3) | TA (15) | 0 | 0.075 | 304 ± 57 |
| 53 | 70 | NF7 (3) | TA (15) | 1 | 0.104 | 211 ± 54 |
| 54 | 100 | NF4 (3) | TA (15) | 0 | 0.106 | 47 ± 18 |
| 55 | 100 | NF4 | TA (15) | 1 | 0.040 | 104 ± 29 |
| 56 | 100 | NF3 | TA (15) | 0 | 0.153 | 78 ± 17 |
| 57 | 100 | NF3 (3) | TA (15) | 1 | 0.087 | 126 ± 30 |
| 58 | 100 | NF7 (3) | TA (15) | 0 | 0.047 | 147 ± 61 |
| 59 | 100 | NF7 (3) | TA (15) | 1 | 0.049 | 138 ± 39 |
| 60 | 130 | NF4 (3) | TA (15) | 0 | 0.053 | 47 ± 18 |
| 61 | 130 | NF4 (3) | TA (15) | 1 | 0.073 | 65 ± 13 |
| 62 | 130 | NF3 (3) | TA (15) | 0 | 0.173 | 60 ± 16 |
| 63 | 130 | NF3 (3) | TA (15) | 1 | 0.082 | 61 ± 11 |
| 64 | 130 | NF7 (3) | TA (15) | 0 | 0.055 | 78 ± 17 |
| 65 | 130 | NF7 (3) | TA (15) | 1 | 0.044 | 72 ± 23 |
| 66 | 130 | None | TA (15) | 1 | 0.122 | 48 ± 12 |

1. A foamable composition comprising:
30 to 92 wt % cellulose acetate;
5 to 30 wt % of at least one plasticizer;
3 to 40 wt % of at least one natural filler; and
0 to 9 wt % of at least one physical blowing agent;
wherein wt % is based on the total weight of the composition,
wherein the cellulose acetate has an average degree of substitution of acetyl in the range from 2.2 to 2.6,
wherein the natural filler is a biodegradable particulate material derived from a renewable organic source, and
wherein the natural filler has a maximum particle size from 50 to 600 microns.

2. (canceled)

3. The foamable composition of claim 1, wherein said at least one plasticizer is selected from the group consisting of triacetin, triethyl citrate, or polyethylene glycol.

4. The foamable composition of claim 1, wherein said natural filler is a biodegradable particulate material derived from a renewable organic source.

5. The foamable composition of claim 4, wherein said natural filler is selected from the group consisting of pecan shell flour, walnut shell flour, wood flour, corn cob flour, rice hull flour, oat fiber powder, or combinations thereof.

6. The foamable composition of claim 1, further comprising an inorganic physical nucleating agent.

7. The foamable composition of claim 1, comprising no inorganic physical nucleating agent.

8. (canceled)

9. The foamable composition of claim 1, wherein said natural filler further comprises up to 22 wt % water based on the dry weight of the natural filler.

10. The foamable composition of claim 1, further comprising a chemical blowing composition comprising: (a) a blowing agent, and (b) a carrier polymer having a melting point that is no more than 180° C.

11. The foamable composition of claim 10, wherein the blowing agent comprises sodium bicarbonate, sodium carbonate, citric acid, or combinations thereof.

12. The foamable composition of claim 10, wherein the carrier polymer is a biodegradable polymer.

13. The foamable composition of claim 12, wherein the carrier polymer comprises a polybutylene succinate (“PBS”), a polycaprolactone (“PCL”), a polylactic acid (“PLA”), a polyhydroxyalkanoate (“PHA”), a polybutylene adipate terephthalate (“PBAT”), a starch derivative, a poly(butylene succinate-cobutylene adipate) (“PBSA”), or combinations thereof.

14. The foamable composition of claim 12, wherein the carrier polymer is present at from 25 to 75 wt % based on the total weight of the chemical blowing composition.

15. The foamable composition of claim 1, in the form of a powder or pellet.

16. A foam formed from the foamable composition of claim 1, wherein in said foam is biodegradable, industrial compostable, or home compostable.

17. The foam of claim 16, wherein said foam has a density of no more than 0.60 g/cm³.

18. The foam of claim 16, wherein said foam has an average cell size of at least 40 μm.

19. The foam of claim 16, wherein said foam comprises no inorganic particulate components.

20. The foam of claim 16, wherein said article is a thermoformed foam article or a molded foam article.
